(19) United States
(12) Patent Application Publication
(10) Pub. No.: US 2019/0315317 A1
(43) Pub. Date: Oct. 17, 2019

(54) IN-VEHICLE VACUUM CLEANER ASSEMBLY

(71) Applicant: SHOP VAC CORPORATION, Williamsport, PA (US)

(72) Inventors: Jason Gottschall, South Williamsport, PA (US); Neil N. Norell, Candor, NY (US)

(21) Appl. No.: 16/376,455

(22) Filed: Apr. 5, 2019

Related U.S. Application Data
(60) Provisional application No. 62/657,443, filed on Apr. 13, 2018.

(51) Int. Cl. B60S 1/64; A47L 9/00; A47L 9/22

(52) U.S. Cl. CPC B60S 1/64; B62D 33/0612; A47L 9/22; A47L 9/0036

(57) ABSTRACT

A vacuum cleaner assembly configured to be mounted in sleeper cab truck. The vacuum cleaner assembly includes a mounting bucket having a vacuum cleaner area having an angled surface and a hose storage area. A vacuum cleaner is disposed in the vacuum cleaner area and includes a collector module having a canister assembly and a vacuum module coupled to the collector module. The vacuum module includes a hose having an end, the hose extending from the vacuum module into the hose storage area of the mounting bucket. The mounting bucket is configured to expose the end of the hose through the hose storage area in any one of a plurality of arrangements to accommodate various mounting positions within the sleeper cab truck.

### CROSS-REFERENCE TO RELATED APPLICATIONS

This application claims the benefit of U.S. Provisional Application No. 62/657,443 filed Apr. 13, 2018. The entire contents of this application is incorporated herein by reference in its entirety.

### FIELD OF THE INVENTION

The present invention relates generally to a vacuum cleaner configured to be mounted in a vehicle, such as a vacuum cleaner assembly mounted in a sleeper cab truck.

### BACKGROUND

In order to clean a vehicle, such as a car or truck, a vacuum cleaner is often used to vacuum out dirt and debris. However, it can be awkward and/or inconvenient to use a typical in-home vacuum cleaner to clean out the interior of a vehicle. To address this inconvenience, attempts have been made to permanently install on-board vehicle vacuum cleaners inside the vehicle. However, the known on-board vehicle vacuum cleaners typically have a complex and dedicated installation arrangement, which limits the usage across different vehicles and/or in different arrangements within a vehicle.

In addition, removal of the vacuum cleaner assembly in a dedicated installation arrangement within the vehicle may be time consuming and difficult. For example, it is often difficult for users to access one or more devices or parts used to help remove the vacuum cleaner assembly from a desired location, such as to remove debris collected in the vacuum cleaner assembly, particularly without spilling the debris. In addition, while some parts may be relatively accessible, they can be heavy or cumbersome to handle, further adding to the difficulties in removing such vacuum cleaner assemblies from various positions within a vehicle.

Further, in many conventional vacuum cleaner assemblies, separate mounting brackets and corresponding fasteners are needed for each of the vacuum cleaner and a hose storage compartment coupled to the vacuum cleaner, for example. As a result, mounting and/or removal of such conventional vacuum cleaner assemblies is typically complex and time consuming and limited in mounting arrangements due to the restrictions in mounting materials and the adaptability and/or flexibility of the same.

### SUMMARY OF THE DISCLOSURE

In accordance with a first exemplary aspect of the present disclosure, a vacuum cleaner assembly configured to be mounted in a vehicle comprises a mounting bucket having a vacuum cleaner area with an angled surface and a hose storage area. A vacuum cleaner is disposed in the vacuum cleaner area of the mounting bucket and includes a collector module configured to collect debris and having a canister assembly disposed on the angled surface of the vacuum cleaner area. The vacuum cleaner further includes a vacuum module configured to draw a vacuum and operatively coupled to the collector module. The vacuum module includes a hose having an end, and the hose extends from the vacuum module into the hose storage area of the mounting bucket. The mounting bucket is configured to expose the end of the hose through the hose storage area in any one of a plurality of arrangements to accommodate various mounting positions in the vehicle.

In accordance with another exemplary aspect of the present disclosure, a vacuum cleaner assembly is configured to be mounted in a vehicle and comprises a mounting bucket having a front portion with an opening, a vacuum cleaner area, and a hose storage area. A holster is aligned with the opening and attached to the front portion of the mounting bucket. A vacuum cleaner is disposed in the vacuum cleaner area of the mounting bucket and includes a collector module configured to collect debris and having a canister assembly disposed in the vacuum cleaner area, and a vacuum module configured to draw a vacuum and operatively coupled to the collector module. The vacuum module includes a hose having an end, the hose extending from the vacuum module into the hose storage area of the mounting bucket and the end extending out of the opening in the front portion of the mounting bucket and into the holster. The end of the hose is removably secured to the holster and accessible from an area outside of the mounting bucket.

In accordance with yet another aspect of the present disclosure, a vacuum cleaner assembly is configured to be mounted in a vehicle and comprises a mounting bucket having a rear portion with an opening, a vacuum cleaner area, a hose storage area, and a wall adapted to be mounted to a first side of an internal wall of the vehicle. A holster is aligned with the opening in the rear portion of the mounting bucket and adapted to be coupled to a second side of the internal wall of the vehicle. A vacuum cleaner is disposed in the vacuum cleaner area of the mounting bucket and includes a collector module configured to collect debris and having a canister assembly disposed on the angled surface of the vacuum cleaner area, and a vacuum module configured to draw a vacuum and operatively coupled to the collector module. The vacuum module includes a hose having an end. The hose extends from the vacuum module into the hose storage area of the mounting bucket and the end extends out of the opening in the rear portion of the mounting bucket and into the holster. So configured, the end of the hose is removably secured to the holster and accessible from a front area of the vehicle.

In accordance with yet another aspect of the present disclosure, a sleeper cab truck comprises a bed support wall, a rear wall disposed opposite the bed support wall, a floor surface disposed between the bed support wall and the rear wall, and a vacuum cleaner assembly disposed on the floor surface. The vacuum cleaner assembly comprises a mounting bucket having a vacuum cleaner area with an angled surface and a hose storage area. A vacuum cleaner is disposed in the vacuum cleaner area of the mounting bucket and includes a collector module and a vacuum module operatively coupled to the collector module. The collector module has a canister assembly disposed on the angled surface of the vacuum cleaner area. The vacuum module includes a hose having an end and extending from the vacuum module into the hose storage area of the mounting bucket. The mounting bucket is configured to expose the end of the hose through the hose storage area in any one of a plurality of arrangements to accommodate various mounting positions on the floor surface.

In further accordance with any one or more of the exemplary aspects, a vacuum cleaner assembly or a sleeper cab truck with a vacuum cleaner assembly may optionally include any one or more of the following preferred forms.

In some preferred forms, the vacuum cleaner area of the mounting bucket may include a latch, and the canister assembly of the collector module may be secured to the vacuum cleaner area by the latch. In addition, the plurality of arrangements of the end of the hose through the hose storage area may include one of a hose through a top portion configuration, a hose through a front portion configuration, and a hose through a rear portion configuration. The collector module may be disposed immediately adjacent to the vacuum module. In addition, the vacuum module may include a motor/impeller unit disposed within a motor housing. Further, the vehicle may include a sleeper cab truck, and the various mounting positions may include attached to one of a floor surface of the sleeper cab truck, a bed support wall of the sleeper cab truck, or a rear wall of the sleeper cab truck.

In other preferred forms, the vacuum cleaner assembly may further comprise a lid secured to the mounting bucket and enclosing the hose storage area. The lid may include a front wall having an opening, a rear wall having an opening, and a top portion having an opening. In addition, each opening may be for receiving the end of the hose in one of the plurality of arrangements of the end of the hose. Further, the end of the hose may be exposed in the opening top portion of the lid in the hose through a top portion configuration. The end of the hose may extend into the opening in the front wall of the lid in the hose through the front wall configuration. In addition, the end of the hose may extend into the opening in the rear wall of the lid in the hose through the rear wall configuration.

In still other preferred forms, the mounting bucket may include one or more of a rear wall having a plurality of wall mount holes and a bottom wall having a plurality of floor mount holes. The mounting bucket may provide a single-piece mounting body for the vacuum cleaner assembly.

In still yet other preferred forms, the vehicle may be a sleeper cab truck, and the mounting bucket may be adapted to be secured to a rear wall of the sleeper cab truck, such that the holster is accessible below a sleeping bed of the sleeper cab truck. In addition, the holster may include a body having a power switch and a nesting section disposed in one end of the body. The nesting section may be for receiving and maintaining a position of the end of the hose when the hose is not in use. So configured, when the end of the hose is disposed in the nesting section of the holster, power is maintained in an off mode.

In still other preferred forms, the vehicle may be a sleeper cab truck, and the mounting bucket may be adapted to be secured to an inside surface of a bed support wall of the sleeper cab truck. In addition, the holster may be adapted to be secured to an outside surface of the bed support wall of the sleeper cab truck adjacent to the opening in the rear portion of the mounting bucket. So configured, the holster may be accessible outside of the bed support wall in a front area of the sleeper cab truck.

In other preferred forms, a lid may be secured to the mounting bucket and enclose the hose storage area, and the lid may further include the rear portion with the opening. The holster may include a body having a power switch and a nesting section disposed in end of the body. The nesting section may be for receiving and maintaining a position of the end of the hose when the hose is not in use. When the end of the hose is disposed in the nesting section of the holster, power may be maintained in an off mode. In addition, when the plurality of arrangements is the hose through a front portion configuration, the mounting bucket may further comprise a rear wall with a plurality of wall mounts, and the rear wall of the mounting bucket may be mounted to the rear wall disposed opposite the bed support wall. Further, when the plurality of arrangements is the hose through a rear portion configuration, the mounting bucket may further include a rear wall with a plurality of wall mounts. The rear wall of the mounting bucket may be mounted to a first side of the bed support wall, and a holster may be mounted to a second side of the bed support wall, such that the end of the hose extends out of the hose storage area of the mounting bucket, through the bed support wall and into the holster.

In still other forms, a holster may be one of coupled to one of a side of the bed support wall and aligned with an opening in a rear portion of the mounting bucket or coupled to a front portion of the mounting bucket and aligned with an opening in the front portion of the mounting bucket. In addition, the holster may include a body having a power switch and a nesting section disposed in one end of the body. The nesting section may be for receiving and maintaining a position of the end of the hose when the hose is not in use.

Additional optional aspects, arrangements, forms, and/or advantages of the vacuum cleaners disclosed herein will be apparent upon consideration of the following detailed description and the appended drawings, each different functionally operable and technically effective combination of which is expressly included as a part of the present disclosure.

### BRIEF DESCRIPTION OF THE DRAWINGS

The Figures described below depict various aspects of the system and methods disclosed therein. It should be understood that each figure depicts an example of a particular aspect of the disclosed system and methods, and that each of the figures is intended to accord with a possible example thereof. Further, wherever possible, the following description refers to the reference numerals included in the following figures, in which features depicted in multiple figures are designated with consistent reference numerals.

There are shown in the drawings arrangements which are presently discussed, it being understood, however, that the present examples are not limited to the precise arrangements and instrumentalities shown, wherein:

FIG. 1 is an isometric view of a vacuum cleaner assembly to be mounted in a vehicle according to an aspect present disclosure, a hose end of the vacuum cleaner assembly in a hose through a top portion configuration;

FIG. 2A is a front view of the vacuum cleaner assembly of FIG. 1;

FIG. 2B is a cross-sectional view of the vacuum cleaner assembly of FIG. 2A, taken along the line A-A of FIG. 2A;

FIG. 2C is another cross-sectional view of the vacuum cleaner assembly of FIG. 2A taken along the line B-B of FIG. 2A;

FIG. 3 is a cross-sectional view of the vacuum cleaner assembly of FIG. 1 taken along the line C-C of FIG. 2A;

FIG. 4 is a rear view of the vacuum cleaner assembly of FIG. 1;

FIG. 5 is a bottom view of the vacuum cleaner assembly of FIG. 1;

FIG. 6 is a top view of the vacuum cleaner assembly of FIG. 1;

FIG. 7 is a perspective view of a portion of a sleeper cab truck having the vacuum cleaner assembly of FIG. 1 disposed therein;

FIG. 8 is an isometric view of another vacuum cleaner assembly to be mounted in a vehicle according to another aspect of the present disclosure, a hose end of the vacuum cleaner assembly in a hose through a front portion configuration;

FIG. 9 is an isometric view of a holster of the vacuum cleaner assembly of FIG. 8;

FIG. 10 is a front view of the vacuum cleaner assembly of FIG. 8;

FIG. 11 is a top view of the vacuum cleaner assembly of FIG. 8;

FIG. 12 is a perspective view of a portion of a sleeper cab truck having the vacuum cleaner assembly of FIG. 8 disposed therein;

FIG. 13 is a side view of a portion of the sleeper cab truck having the vacuum cleaner assembly of FIG. 8 disposed therein;

FIG. 14 is a rear, isometric view of another vacuum cleaner assembly to be mounted in a vehicle according to another aspect of the present disclosure, a hose end of the vacuum cleaner assembly in a hose through a rear portion configuration and disposed through a wall of the vehicle;

FIG. 15 is a front, isometric view of the vacuum cleaner assembly of FIG. 14;

FIG. 16 is a top view of the vacuum cleaner assembly of FIG. 14;

FIG. 17 is a front, perspective view of a portion of the sleeper cab truck having the vacuum cleaner assembly of FIG. 14 disposed therein;

FIG. 18 is a rear, perspective view of a portion of the sleeper cab truck having the vacuum cleaner assembly of FIG. 14 disposed therein; and

FIG. 19 is a side view of a portion of the sleeper cab truck having the vacuum cleaner assembly of FIG. 14 disposed therein.

### DETAILED DESCRIPTION

A vacuum cleaner assembly configured to be mounted in a vehicle, such as a sleeper cab truck, is disclosed. The vacuum cleaner assembly includes a mounting bucket having a vacuum cleaner area with an angled surface and a hose storage area. A vacuum cleaner is disposed in the vacuum cleaner area and includes a collector module having a canister assembly disposed on the angled surface and a vacuum module coupled to the collector module. The vacuum module includes a hose having an end, and the hose extends into the hose storage area of the mounting bucket. So configured, the mounting bucket is able to expose the end of the hose through the hose storage area in any one of a plurality of arrangements to accommodate various mounting positions in the vehicle. Said another way, the mounting bucket provides a single-piece mounting body for the vacuum cleaner assembly for use with various mounting positions in the vehicle and various arrangements of the end of the hose of the vacuum cleaner assembly. The plurality of arrangements of the end of the hose through the hose storage area of the vacuum cleaner assembly includes any one of a hose-through-a-top-portion configuration, a hose-through-a-front-portion configuration, and a hose-through-a-rear-portion configuration, all of which the mounting bucket of the vacuum cleaner assembly of the present disclosure may accommodate, as explained more below.

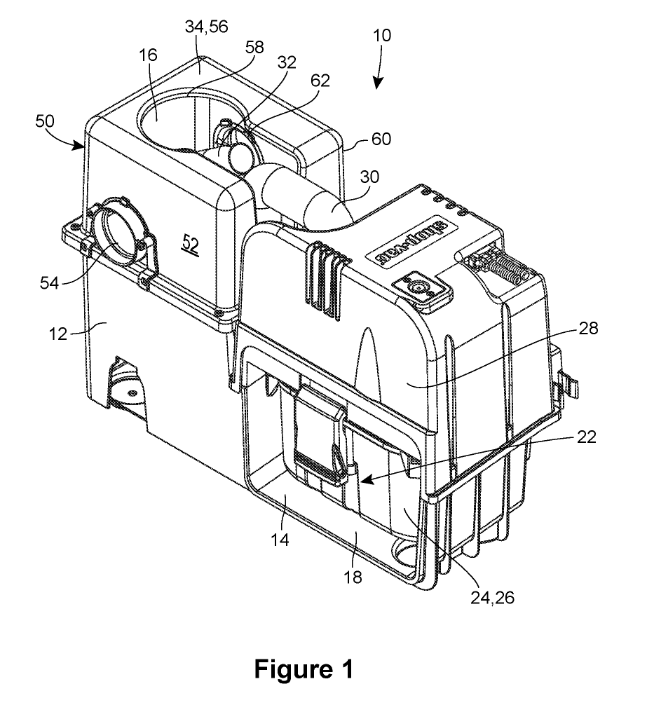

Referring now to FIGS. 1-7, a vacuum cleaner assembly 10 to be mounted in a vehicle according to an aspect of the present disclosure is depicted. The vacuum cleaner assembly 10 is disposed in a hose through a top portion configuration, which includes a hose end of the vacuum cleaner assembly exposed through a top portion of the vacuum cleaner assembly, as explained more below.

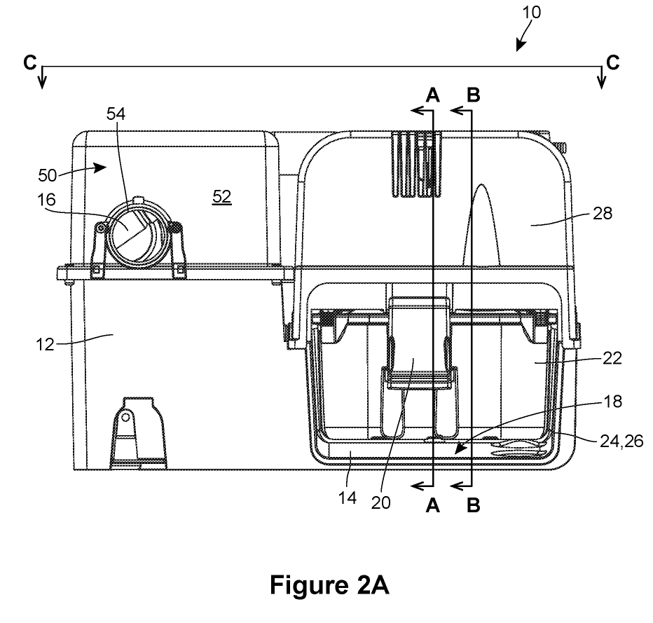

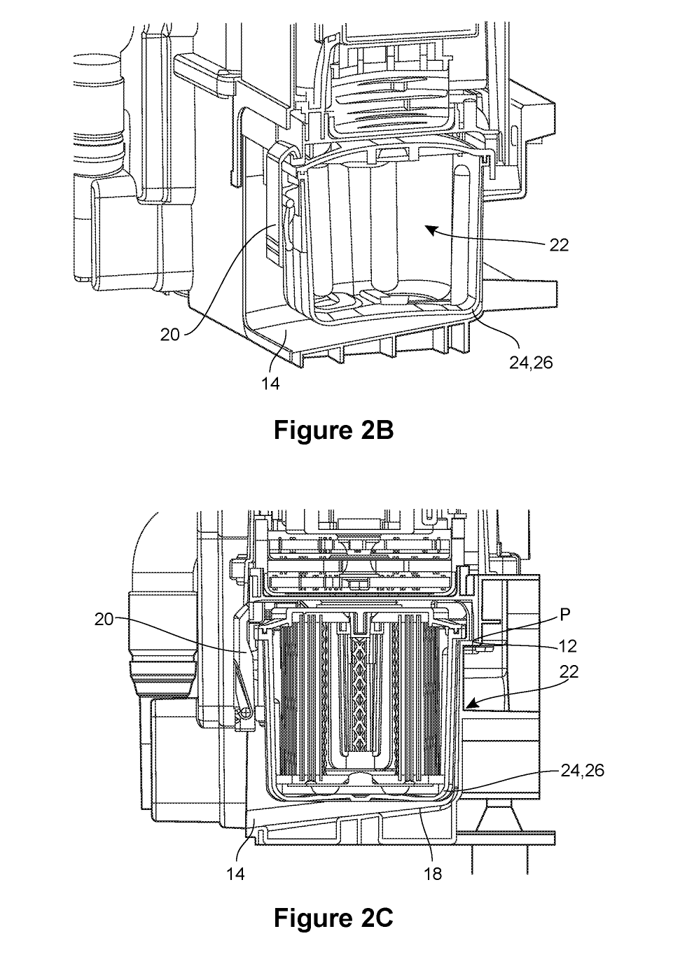

More specifically, and referring now to FIGS. 1 and 2A-2C the vacuum cleaner assembly 10 includes a mounting bucket 12 having a vacuum cleaner area 14 and a hose storage area 16. The vacuum cleaner area 14 includes an angled surface 18, such as an angled floor surface, and a latch 20 for securing a vacuum cleaner to the vacuum cleaner area 14, for example, as explained more below. The vacuum cleaner assembly 10 further includes a vacuum cleaner 22 disposed in the vacuum cleaner area 14 of the mounting bucket 12. The vacuum cleaner 22 includes a collector module 24 configured to collect debris and having a canister assembly 26, which is initially disposed on the angled surface 18 of the vacuum cleaner area 14 upon placement of the vacuum cleaner 22 into the vacuum cleaner area 14 and before being secured by the latch 20. The canister assembly 26 is secured to the vacuum cleaner area 14 of the mounting bucket 12 by the latch 20. In one example, a user puts the latch 20 up and buckles the canister assembly 26 down, such that the canister assembly 26 is pulled upward and is no longer disposed on the angled surface 18 or any part of a liner when secured by the latch 20, as depicted in FIGS. 2B and 2C. As depicted in FIG. 2C, when the canister assembly 26 is secured by the latch 20, the canister assembly 26 pivots on the mounting bucket 12 at pivot point P. In other words, when the latch 20 is drawn up, the canister assembly 26 pivots on the mounting bucket 20 at pivot point P. While a latch 20 is depicted, various other securing mechanisms may alternatively and/or additionally be used to secure the vacuum cleaner to the vacuum cleaner area 14 in the mounting bucket 12 and still fall within the scope of the present disclosure.

The vacuum cleaner 22 further includes a vacuum module 28 configured to draw a vacuum and operatively coupled to the collector module 24 and immediately adjacent to the collector module 24. The vacuum module 28 includes a hose 30 (FIG. 1) having an end 32. The hose 30 extends from the vacuum module 28 into the hose storage area 16 of the mounting bucket 12, as depicted in FIG. 1. So configured, and in this example, the mounting bucket 12 exposes the end 32 of the hose 30 of the vacuum cleaner assembly 10 one or more of through or at a top portion 34 of the hose storage location 16. This is one hose arrangement of a plurality of arrangements that the end 32 of the hose 30 may be accommodated in the vacuum cleaner assembly 10 of the present disclosure.

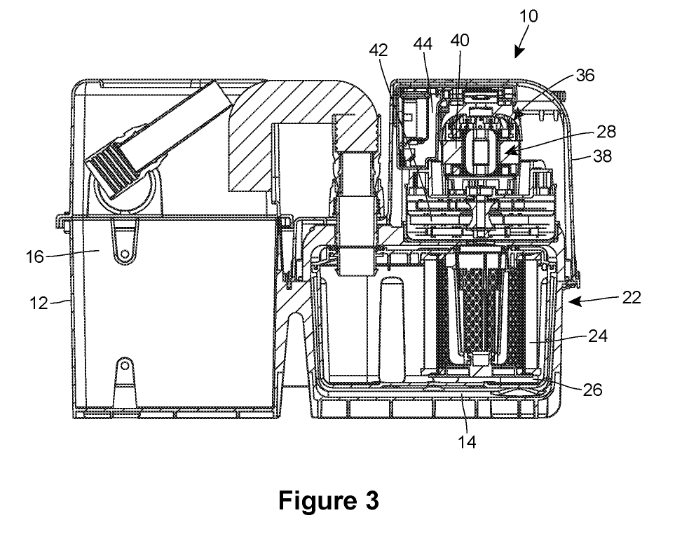

Referring now to FIG. 3, the vacuum module 28 includes a motor/impeller unit 36 and a motor housing 38. In this example, the motor housing 38 is in the form of an outer shell having a generally rectangular form. However, the motor housing 38 may take many different forms, shapes and sizes depending upon the particular space needs and/or arrangements desired for installation in a vehicle, such as the sleeper cab truck. The motor/impeller unit 36 includes a motor 40 that drives an impeller assembly 42 and a controller 44 that controls the motor 40. The motor 40 can be of any suitable design for vacuum cleaners, including standard motors with brushes or brushless motors, including switched reluctance motors. The impeller assembly 42 may take any form suitable for moving air in a manner that will create a vacuum. The impeller assembly 42 may also include any number of impellers and still fall within the scope of the present disclosure. The controller 44 includes suitable electronics, such as a PCB board and/or other appropriate electronic control circuits configured to control the motor 40.

Referring back to FIG. 1, the vacuum cleaner assembly 10 may further include a lid 50 secured to the mounting bucket 12 and enclosing the hose storage area 16. In one example, the lid 50 includes a front wall 52 having an opening 54, a top portion 56 having an opening 58, and a rear wall 60 having an opening 62. Each of the openings 54, 58, and 62 is able to receive the end 32 of the hose 30. In addition, each of the openings 54, 58, and 62 corresponds to one of the plurality of arrangements of the end 32 of the hose 30 of the vacuum cleaner assembly 10. While the lid 50 is rectangular in shape, one of skill in the art will appreciate that other similar structural components having various other shapes and sizes may alternatively be used and still fall within the scope of the present disclosure.

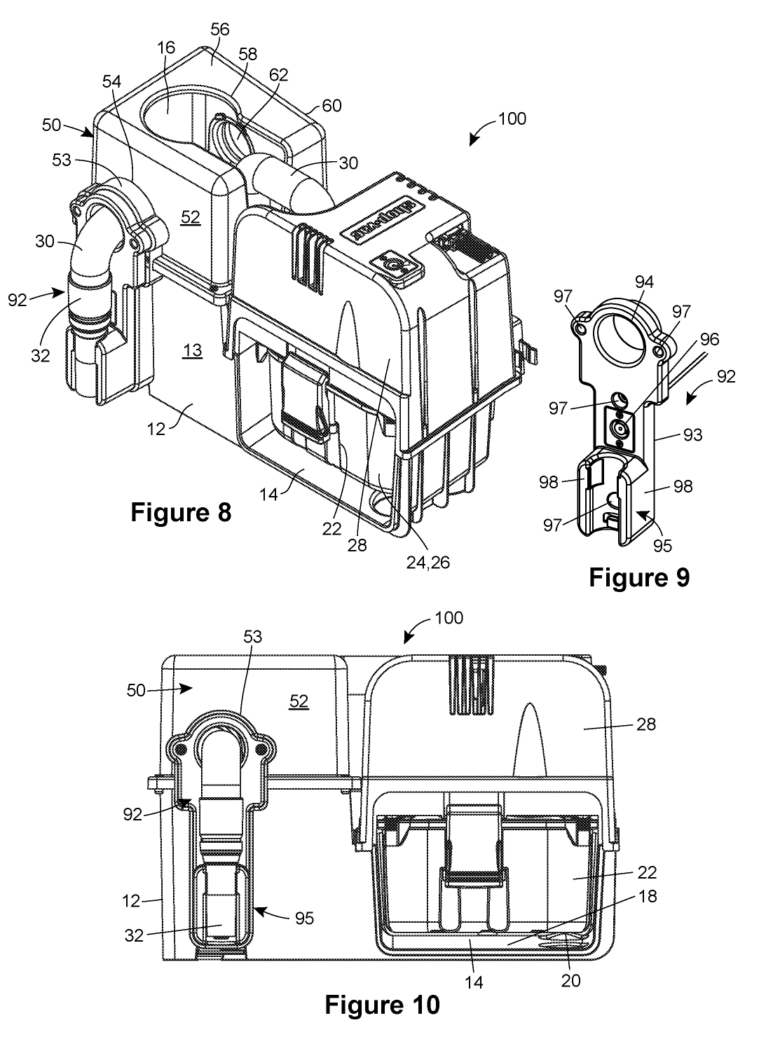

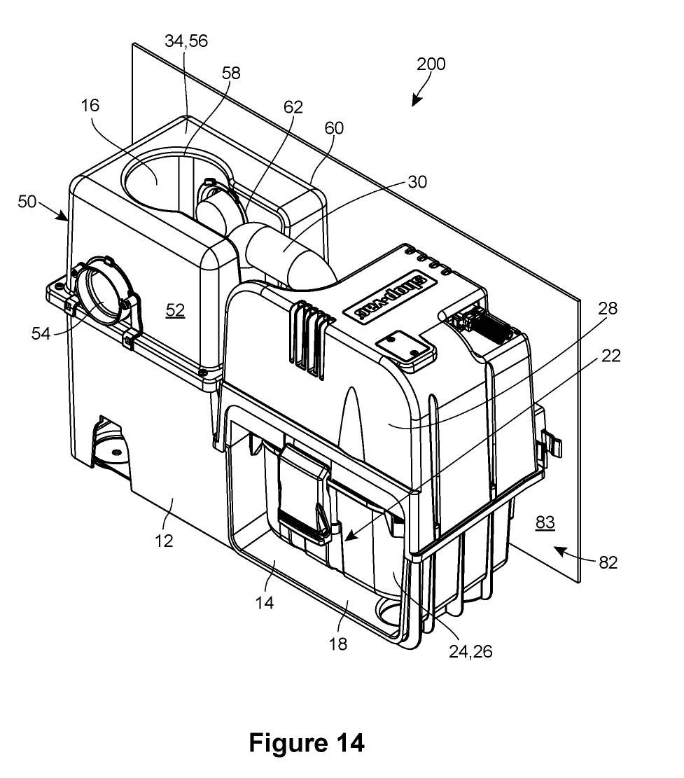

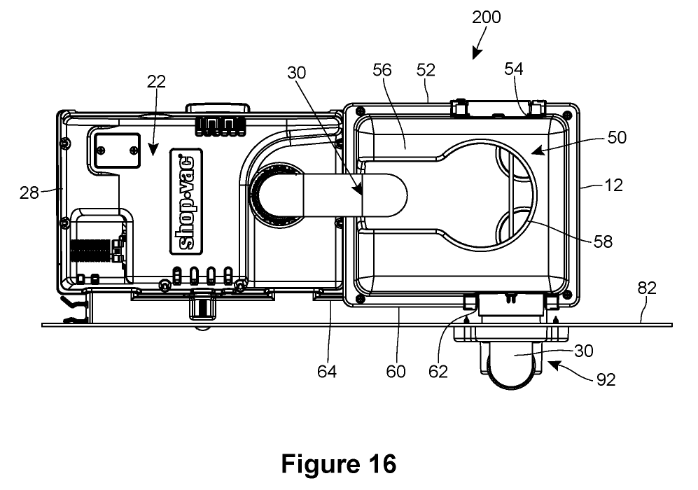

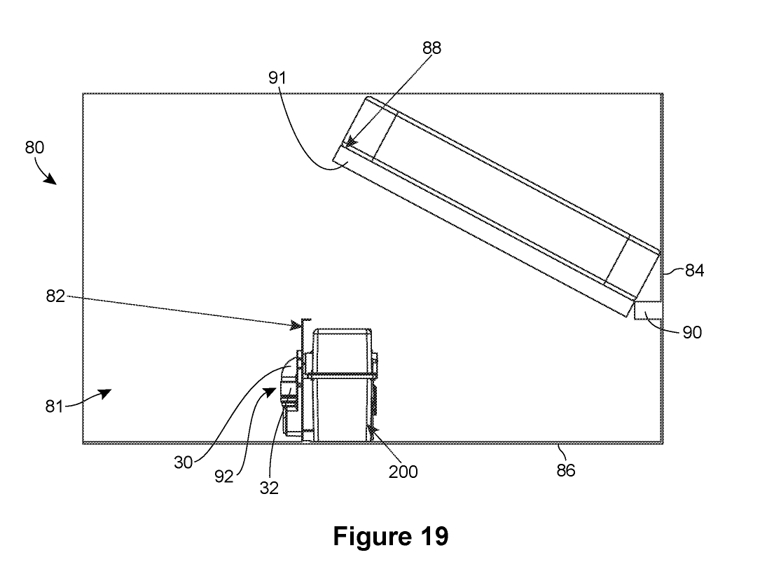

When the end 32 of the hose 30 is exposed through the opening 58 in the top portion 56 of the lid 50, as depicted in FIGS. 1-7, the vacuum cleaner assembly 10 is in a hose-through-a-top-portion configuration. In addition, when the end 32 of the hose 30 extends through the opening 54 in the front wall 52 of the lid 50, the vacuum cleaner assembly 10 is in a hose-through-a-front-portion configuration, as depicted in FIGS. 8-13. Further, when the end 32 of the hose 30 extends through the opening 62 in the rear wall 60 of the lid 50, the vacuum cleaner assembly 10 is in a hose-through-a-rear-wall configuration, as depicted in FIGS. 14-19, and explained more below.

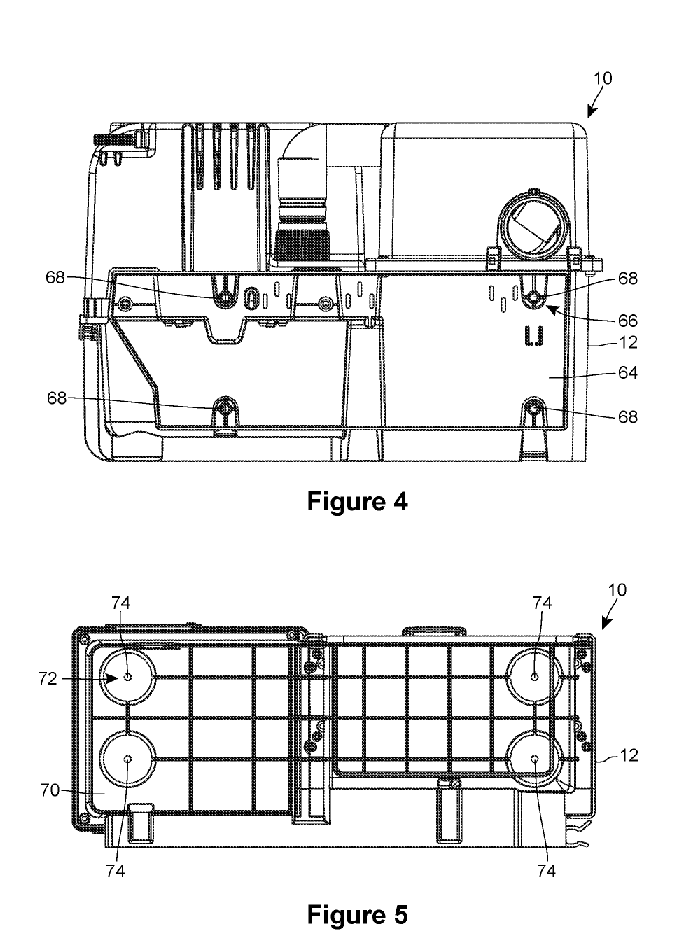

Referring now to FIG. 4, the mounting bucket 12 of the vacuum cleaner assembly 10 further includes a rear wall 64 having a plurality of wall mount holes 66. In one example, the plurality of wall mount holes 66 includes four holes 68. It will be appreciated that more or fewer than four mount holes 68 may alternatively be used and still fall within the scope of the present disclosure. Depending upon the configuration of the hose end 30, the plurality of wall mount holes 66 may be used to secure the vacuum cleaner assembly 10 to a vehicle, such as the sleeper cab truck.

Referring now to FIG. 5, the mounting bucket 12 of the vacuum cleaner assembly 10 also includes a bottom wall 70 having a plurality of floor mount holes 72. In one example, the plurality of floor mount holes 72 includes four floor mount holes 74. It will again be appreciated that more or fewer than four floor mount holes 74 may alternatively be used and still fall within the scope of the present disclosure. In addition, depending upon the configuration of the hose end 30, the plurality of floor mount holes 72 may or may not be used to mount the vacuum cleaner assembly 10 to the vehicle.

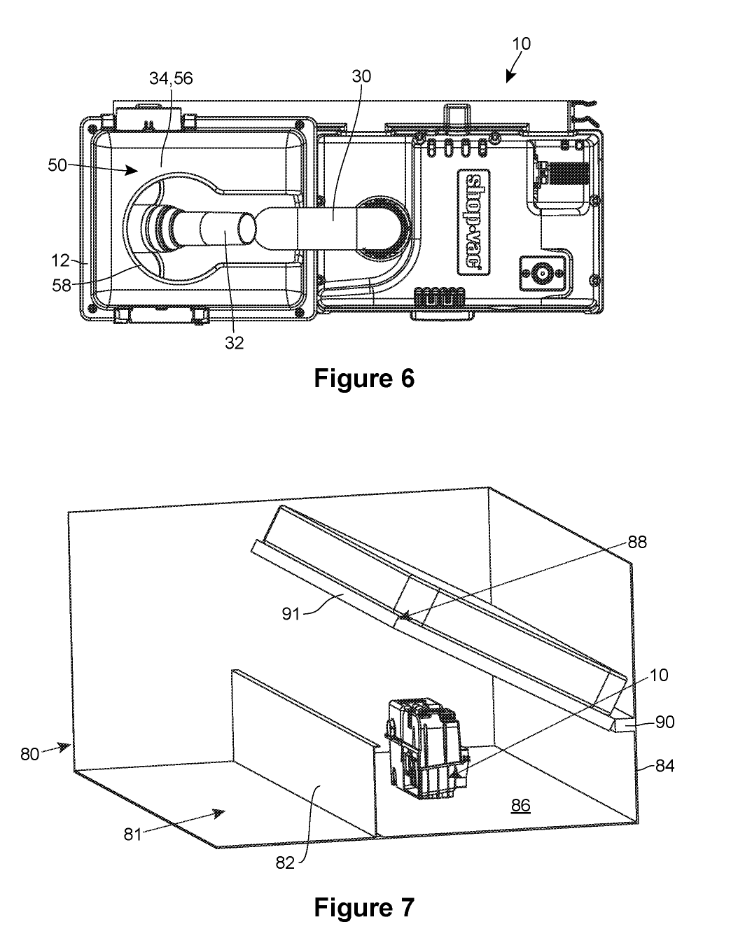

Referring now to FIG. 6, a top view of the vacuum cleaner assembly 10 is depicted. The end 32 of the hose 30 rests and/or partially extends out of the opening 58 in the top portion 56 of the lid 50 secured to the mounting bucket 12. The opening 58 is partially circular and partially rectangular in shape to accommodate the corresponding shapes of each of the end 32 of the hose 30 and a body of the hose 30, respectively. Alternatively, the opening 58 may take the form of various other shapes and sizes capable of receiving the end 32 of the hose 30, for example, and still fall within the scope of the present disclosure.

As depicted in FIG. 7, a portion of a sleeper cab truck 80 is depicted having the vacuum cleaner assembly 10 with the hose-out-of-a-top-portion configuration of FIGS. 1-6 disposed therein. The sleeper cab truck 80 includes a front area 81, a bed support wall 82, a rear wall 84 disposed opposite the bed support wall 82, and a floor surface 86 disposed between the bed support wall 82 and the rear wall 84. The sleeper cab truck 80 further includes a bed bunk 88 having a first end 90 pivotably attached to the rear wall 84 of the sleeper cab truck 80 and a second end 91 that is supported by the bed support wall 82 when the bed bunk 88 is in a closed position (not depicted). In FIG. 7, the bed bunk 88 is in an open position, providing access to the floor surface 86 disposed between the bed support wall 82 and the rear wall 84. Thus, when the bed bunk 88 is in this open position, the vacuum cleaner assembly 10 is able to be mounted in any position under the bed bunk 88, such as mounted to a center area of the floor surface 86, as depicted, via the plurality of mounting holes 72 (FIG. 5) and corresponding fasteners (not depicted) disposed on the bottom wall 70 of the vacuum cleaner assembly 10. Once mounted to the floor surface 86, the end 32 of the hose 30 is accessible through the top portion 34 of the mounting bucket 12, as previously explained, allowing a user to easily vacuum in and around the entire floor surface 86 of the sleeper cab truck 80.

Referring now to FIGS. 8-13, a vacuum cleaner assembly 100 according to another aspect of the present disclosure is depicted. The vacuum cleaner assembly 100 is identical to the vacuum cleaner assembly 10 of FIGS. 1-7, except the end 32 of the hose 30 of the vacuum cleaner 100 is in the hose-through-a-front-portion configuration, different from the hose-through-a-top-portion configuration of FIGS. 1-7. To accommodate the hose-through-a-front-portion configuration, the vacuum cleaner assembly 100 also includes a holster, as described more below. For the sake of brevity, parts of the vacuum cleaner assembly 100 the same as parts of the vacuum cleaner assembly 10 of FIGS. 1-7 have the same reference numbers and are not described here again.

Referring now to FIG. 8, the vacuum cleaner assembly 100 is depicted in the hose-through-a-front-portion configuration. In this example, the vacuum cleaner assembly 100 further includes a holster 92 for receiving the end 32 of the hose 30 extending from the vacuum module 28 of the vacuum cleaner 22. The holster 92 is aligned with the opening 54 of a front portion 13 of the mounting bucket 12, which may be a portion of the lid 50 in some examples, and attached to an area that may include both the front portion 13 and the front portion 52 of the lid 50 coupled to the mounting bucket 12, as depicted in FIG. 8. In one example, the holster 92 is attached to a holster mount 53, as depicted in FIGS. 8 and 10, and the holster mount 53 is attached to the area that may include both the front portion 13 and the front portion 52 of the lid 50 coupled to the mounting bucket 12. So configured, the hose 30 extends from the vacuum module 28 into the hose storage area 16 of the mounting bucket 12, and the end 32 of the hose 30 extends out of the opening 54 in the front portion 52 of the lid 50 of the mounting bucket 12 and into the holster 92 disposed outside of the mounting bucket 12. In this way, the end 32 of the hose 30 is removably secured to the holster 92 and accessible from an area outside of the mounting bucket 12.

Referring now to FIG. 9, the holster 92 includes a body 93 with an opening 94 on one end of the body and a nesting section 95 on the other end of the body 93. The nesting section 95 receives and maintains a position of the end 32 of the hose 30 when the hose 30 is not in use, for example. In addition, the holster 92 also includes a power switch 96 disposed in a central area of the body 93. When the end 32 of the hose 30 is disposed in the nesting section 95 of the holster 92, power is maintained in an off mode. When the end 32 of the hose 30 is removed from the nesting section 95 of the holster 92, the power switch 96 may be actuated to change the power supplied to an on mode. The opening 94 of the holster 92 is aligned with the opening 54 of the front portion 52 of the lid 50 or, more generally, another opening in the mounting bucket 12. The end of the holster 92 having the opening 94 also includes a pair of mounting holes 97 that align with corresponding mounting holes on a port aligned with the opening 54 of mounting bucket 12. The mounting holes 97 receive fasteners to secure the holster 92 to the holster mount 53, which is secured to the mounting bucket 12 of the vacuum cleaner assembly 100. Another mounting hole 97 is disposed above the power switch 96 to further secure the holster 92 to the mounting bucket 12. In another example, the holster 92 may include all of the features described above, except the power switch 96. Although this is not depicted in the figures, in this example, the power switch may have an alternative location not on the holster 92, but another area of the vacuum cleaner assembly 100.

The nesting section 95 includes a pair of sides 98 having a longitudinal bore disposed between the pair of sides 98. The longitudinal bore receives the end 32 of the hose 30. The nesting section 95 also includes a mounting hole 97 for receiving a fastener to further secure the holster 92 to the mounting bucket 12.

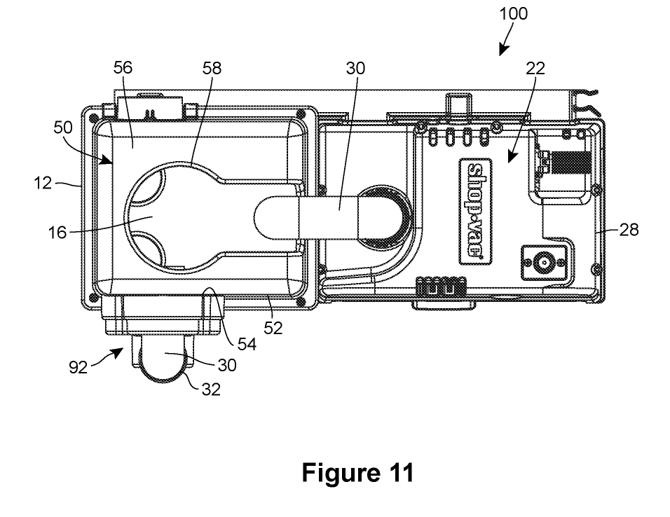

As further depicted in FIGS. 10 and 11, in this arrangement the hose 30 extends from the vacuum module 28 of the vacuum cleaner 22 and into the hose storage area 16 of the mounting bucket 12. The end 32 of the hose 30 is disposed in the nesting section 95 of the holster 92 (FIG. 10) and is maintained in this position when the hose 30 is not being used, for example.

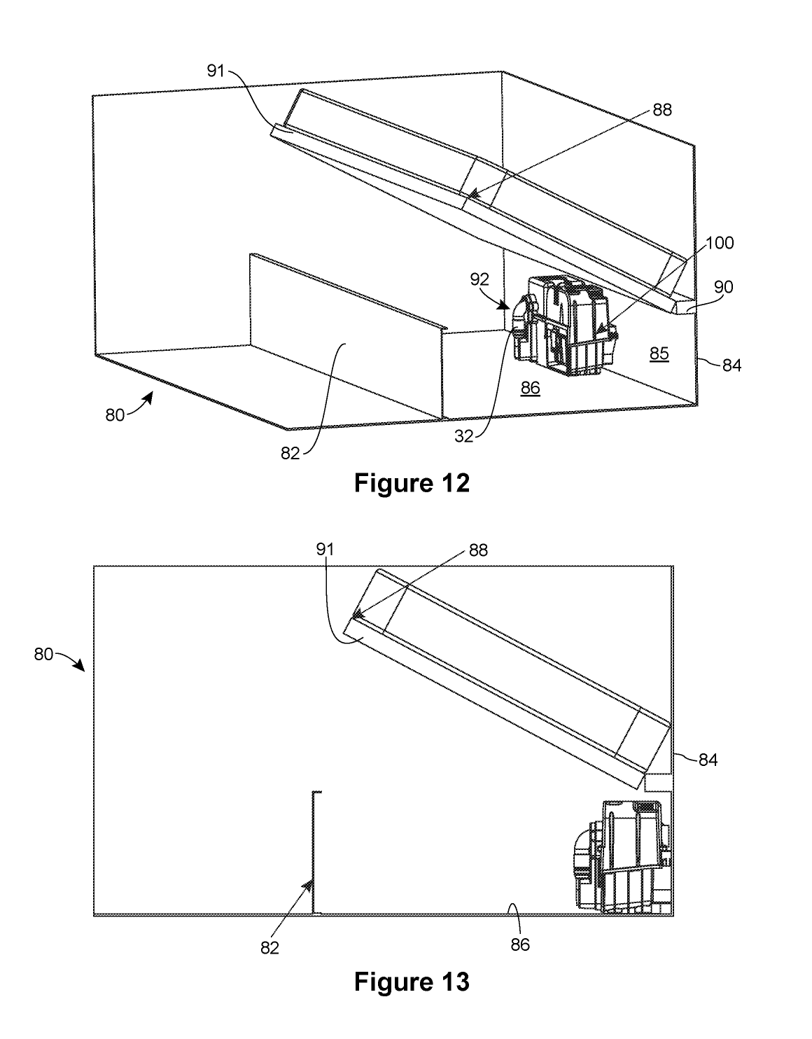

Referring now to FIGS. 12 and 13, the vacuum cleaner assembly 100 is depicted disposed in the sleeper cab truck 80. Instead of being disposed in a central area of the floor surface 86 of the sleeper cab truck 80 like the vacuum cleaner assembly 10 of FIGS. 1-7, the vacuum cleaner assembly 10 having the hose-through-a-front configuration is instead mounted to the rear wall 84 of the sleeper cab truck 80, even though this configuration could still be mounted to a central area of the floor surface 86, if desired. More specifically, like the vacuum cleaner assembly 10 of FIGS. 1-7, the vacuum cleaner assembly 100 includes the rear wall 64 having the plurality of mounting holes 66 (FIG. 4). Each hole 68 of the plurality of holes 66 receives a fastening member to mount the vacuum cleaner assembly 100 to an inside surface 85 of the rear wall 84 of the sleeper cab truck 80. So configured, the end 32 of the hose 30 disposed in the holster 92 is accessible below the bed bunk 88 and in an area of the sleeper cab truck 80 disposed above the floor surface 86 when the bed bunk 88 is in the open position depicted in FIG. 12, for example. In this way, the vacuum cleaner assembly 100 is easily mounted to the rear wall 84, disposed away from the front area of the sleeper cab truck 80, and the end 32 of the hose 30 is easily accessible when the bed bunk 88 is in the open position, allowing the area on and around the floor surface 86 to be vacuumed.

Referring now to FIGS. 14-19, a vacuum cleaner assembly 200 according to another aspect of the present disclosure is depicted. The vacuum cleaner assembly 200 is identical to the vacuum cleaner assembly 10 of FIGS. 1-7, except the end 32 of the hose 30 of the vacuum cleaner 22 is in the hose-through-a-rear-portion configuration, different from both the hose-through-a-top-portion configuration of the vacuum cleaner assembly 10 of FIGS. 1-7 and the hose-through-a-front-portion configuration of the vacuum cleaner assembly 100 of FIGS. 8-13. To accommodate the hose through the rear portion configuration, the vacuum cleaner assembly 200 also includes the holster 92, but the holster 92 is coupled to the rear portion of the mounting bucket 12 via the bed support wall 82 of the sleeper cab truck 80, as explained more below. This configuration is unlike the vacuum cleaner assembly 100 of FIGS. 8-13, for example, in which the holster 92 is directly coupled to the front portion of the mounting bucket 12, as described above. For the sake of brevity, parts of the vacuum cleaner assembly 200 the same as parts of the vacuum cleaner assemblies 10 and 100 have the same reference numbers and are not described here again.

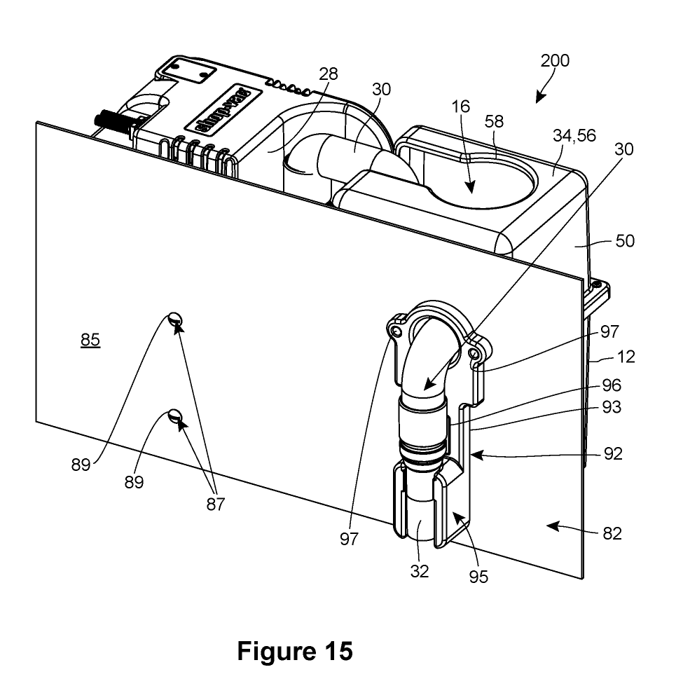

Referring now to FIGS. 14-16, the vacuum cleaner is depicted in a hose-through-a-rear-portion or the rear portion configuration. In this example, the rear wall 60 of the mounting bucket 12 is adapted to be or mounted to a first side 83 of an internal wall 82 of a vehicle, a portion of which is depicted in FIG. 14. In one example, the first side 83 of the internal wall 82 is the first side 83 of the bed support wall 82 of the sleeper cab truck, as depicted in FIG. 18, explained more below. In addition, and referring now to FIG. 15, the holster 92 is aligned with the opening 62 in the rear wall 60 of the lid 50. More generally, the holster 92 may be aligned with an opening in a rear portion of the mounting bucket 12 separate from the lid 50 in examples of the mounting bucket 12 having an enclosure different from the lid 50, for example. The holster 92 is also coupled to a second side 85 of the internal wall 82 of the vehicle. So configured, the hose 30 extends from the vacuum module 28 into the hose storage area 16 of the mounting bucket 12 and the end 32 extends out of the opening 62 in the rear portion of the mounting bucket 12 and into the holster 92. In this way, the end 32 of the hose 30 is removably secured to the holster 92 and accessible from an area outside of the internal wall 82 of the vehicle, as explained more below. In addition, the end 32 of the hose 30 is disposed in the nesting section 95 of the holster 92 and is maintained in this position when the hose 30 is not in use.

Referring now to FIG. 15, the rear wall 64 of the mounting bucket 12 is secured to the internal wall 82 by both a plurality of bolts 87 and the holster 92. More specifically, some wall mount holes 68 (FIG. 4) of the plurality of wall mount holes 66 of the rear wall 64 receive the bolts 87 and other wall mount holes 68 of the plurality of wall mount holes 66 receive fasteners that secure the holster 92 to the internal wall 82. In one example, the bolts 87 are inserted through holes 89 in the internal wall 82 and into a pair of wall mount holes 68 of the rear wall 64 of the mounting bucket 12 disposed below the vacuum cleaner module 28. In addition, the other pair of wall mount holes 68 of the rear wall 64 of the mounting bucket 12 disposed below the lid 50 (FIG. 4) receive fasteners that secure the holster 92 to the internal wall 82.

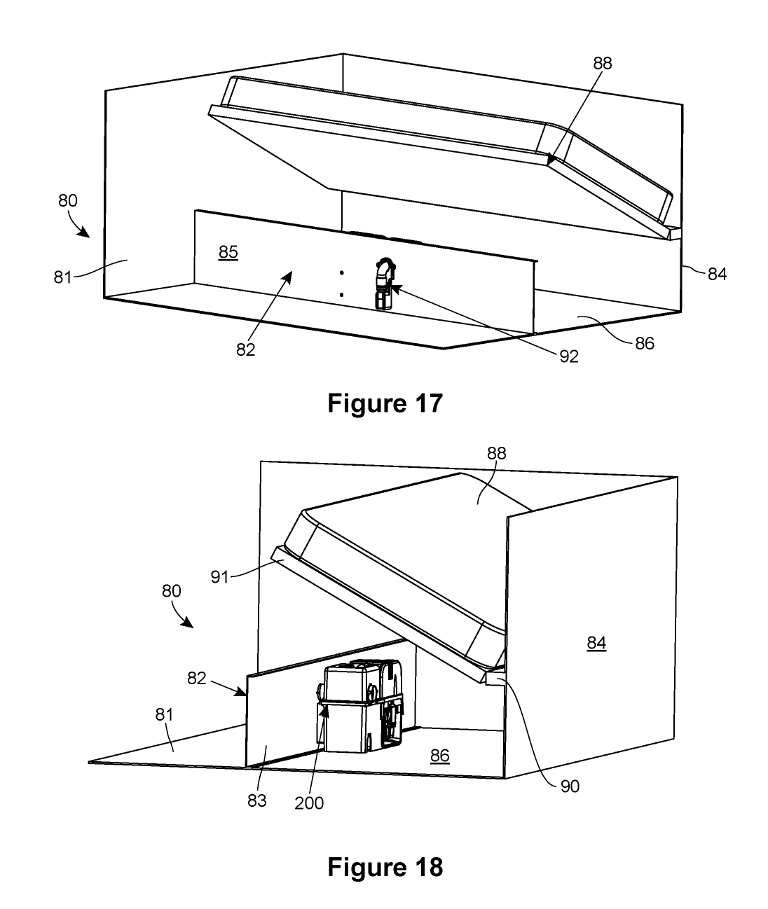

Referring now to FIGS. 17-19, the vacuum cleaner assembly 200 is depicted disposed in the sleeper cab truck 80. Instead of being disposed in a central area of the floor surface 86 like the vacuum cleaner assembly 10 (FIGS. 1-7) or mounted to the rear wall 84 like the vacuum cleaner assembly 100 (FIGS. 8-13), the vacuum cleaner assembly 200 having the hose through the rear portion configuration is mounted to the bed support wall 82 of the sleeper cab truck 80. The vacuum cleaner assembly 200 includes the rear wall 64 having the plurality of mounting holes 66 (FIG. 4). A pair of mounting holes 66 in the mounting bucket 12 disposed below the vacuum module 28 receive fastening members 87, such as bolts, to mount the vacuum cleaner assembly 200 to an inside surface 83 (FIG. 17) of the bed support wall 82 of the sleeper cab truck 80.

In addition, the mounting holes 97 in the body 93 of the holster 92 align with the other pair of holes 89 (not shown) in the bed support wall 82 that are aligned with other pair of mounting holes 66 in the rear wall 64 in the mounting bucket 12 disposed below the lid 50, for example. Another pair of fasteners, such as bolts, are then inserted through the mounting holes 97 in the body 93 of the holster 92, through the aligned holes 89 in the bed support wall 82 and into the aligned mounting holes 68 in the rear wall 64 of the mounting bucket 12 disposed below the lid 50, for example. In addition, the upper two mounting holes 97 of the holster 92 (see, e.g., FIG. 15) also receive fasteners that are inserted into the bed support wall 82 only, and not the rear wall 64 of the mounting bucket 12, for example. So configured, the holster 92 is mounted to the second side 85 (FIG. 17) of the bed support wall 82 via fasteners that extend through mounting holes 97 in the body 93 of the holster, into the second side 85 of the bed support wall 82 and into the mounting holes of the rear wall 64 of the mounting bucket 12, and other fasteners that extend through the upper two mounting holes 97 and into the bed support wall 82, thereby mounting the vacuum cleaner assembly 200 to the bed support wall 82. In this manner, one or more of the bolts 87 and the holster 92 secure the vacuum cleaner assembly 200 to the inside surface 83 of the bed support wall 82.

So configured, the end 32 of the hose 30 extends out of the hose storage area 16 of the mounting bucket 12, through the bed support wall 82 and into the holster 92 disposed on the second side 85 of the bed support wall. As a result, the end 32 of the hose 30 is accessible from a front area 81 of the sleeper cab truck 80 outside of the bed bunk 88, allowing the front area 81 of the sleeper cab truck to be easily vacuumed.

In view of the foregoing, it will be understood that the various vacuum cleaner assemblies 10, 100, and 200 of the present disclosure have several advantages over conventional vacuum cleaner assemblies. For example, because the vacuum cleaner area 14 of the mounting bucket 12 includes the angled surface 18, the canister assembly 26 rides or is disposed on the angled surface 18, such as the angled floor, of the vacuum cleaner area 14 until the latch 20 is pulled up and the canister assembly 26 is buckled down in place. So configured, the canister assembly 26 is pulled upward and is no longer disposed on the angled surface 18 or any part of a liner. As a result, a liner disposed within the vacuum cleaner area is not needed, creating a more simple design of the vacuum cleaner assemblies 10, 100, 200.

In addition, the single-piece construction of the mounting bucket 12 with universal wall mount holes 68 on the rear wall 64 of the mounting bucket 12 and the floor mount holes 72 on the bottom wall 70 eliminate a need for a separate hose bucket compartment and mounting brackets for each of the hose bucket compartment and the vacuum clean assembly. As a result, the vacuum cleaner assemblies 10, 100, 200 have increased flexibility and universal mounting features for many positions within the sleeper cab truck, including mounted to the rear wall 84, the front wall 82 and/or the floor surface 86 of the sleeper cab truck 80. Said another way, the single piece mounting bucket 12 includes mounting features capable of being used to mount the vacuum cleaner assemblies 10, 100, 200 to the rear wall 84, the front wall 82 and/or the floor surface 86 between the front and rear walls 82, 84 beneath the bed bunk 88 of the sleeper cab truck 80.

Still further, the unique holster 92 secures the end 32 of the hose 30 while the hose is not in use and may further maintain power in an off position while the end 32 of the hose 30 is secured within the holster 92, in some examples. Thus, the holster 92 serves as both a safety and organizational feature for the vacuum cleaner assemblies 100, 200.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one example” or “an example” means that a particular element, feature, structure, or characteristic described in connection with the embodiment is included in at least one embodiment. The appearances of the phrase “in one example” in various places in the specification are not necessarily all referring to the same example.

Some examples may be described using the expression “coupled” and “connected” along with their derivatives. For example, some examples may be described using the term “coupled” to indicate that two or more elements are in direct physical or electrical contact. The term “coupled,” however, may also mean that two or more elements are not in direct contact with each other, but yet still cooperate or interact with each other. The examples are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

While various embodiments have been described herein, it is understood that the appended claims are not intended to be limited thereto, and may include variations that are still within the literal or equivalent scope of the claims.

1. A vacuum cleaner assembly configured to be mounted in a vehicle, the vacuum cleaner assembly comprising:
a mounting bucket having a vacuum cleaner area and a hose storage area, the vacuum cleaner area having an angled surface;
a vacuum cleaner disposed in the vacuum cleaner area of the mounting bucket, the vacuum cleaner including:
a collector module configured to collect debris and having a canister assembly disposed on the angled surface of the vacuum cleaner area; and
a vacuum module configured to draw a vacuum and operatively coupled to the collector module, the vacuum module including a hose having an end, the hose extending from the vacuum module into the hose storage area of the mounting bucket,
where the mounting bucket is configured to expose the end of the hose through the hose storage area in any one of a plurality of arrangements to accommodate various mounting positions in the vehicle.

2. The vacuum cleaner assembly of claim 1, wherein the vacuum cleaner area of the mounting bucket further includes a latch, and the canister assembly of the collector module is secured to the vacuum cleaner area by the latch.

3. The vacuum cleaner assembly of claim 1, wherein the plurality of arrangements of the end of the hose through the hose storage area includes one of a hose-through-a-top-portion configuration, a hose-through-a-front-portion configuration, and a hose-through-a-rear-portion configuration.

4. The vacuum cleaner assembly of claim 1, wherein the collector module is disposed immediately adjacent to the vacuum module.

5. The vacuum cleaner assembly of claim 1, wherein the vacuum module includes a motor/impeller unit disposed within a motor housing.

6. The vacuum cleaner assembly of claim 1, wherein the vehicle is a sleeper cab truck, and the various mounting positions include attached to one of a floor surface of the sleeper cab truck, a bed support wall of the sleeper cab truck, or a rear wall of the sleeper cab truck.

7. The vacuum cleaner assembly of claim 1, further comprising a lid secured to the mounting bucket and enclosing the hose storage area, the lid including a front wall having an opening, a rear wall having an opening, and a top portion having an opening, each opening for receiving the end of the hose in one of the plurality of arrangements of the end of the hose.

8. The vacuum cleaner assembly of claim 3, wherein the end of the hose is exposed in the opening top portion of the lid in the hose-through-a-top-portion configuration, the end of the hose extends into the opening in the front wall of the lid in the hose-through-the-front-portion configuration, and the end of the hose extends into the opening in the rear wall of the lid in the hose-through-a-rear-portion configuration.

9. The vacuum cleaner assembly of claim 1, wherein the mounting bucket includes one or more of a rear wall having a plurality of wall mount holes and a bottom wall having a plurality of floor mount holes, the mounting bucket providing a single-piece mounting body for the vacuum cleaner assembly.

10. A vacuum cleaner assembly configured to be mounted in a vehicle, the vacuum cleaner assembly comprising:
a mounting bucket having a front portion with an opening, a vacuum cleaner area, and a hose storage area;
a holster aligned with the opening and attached to the front portion of the mounting bucket;
a vacuum cleaner disposed in the vacuum cleaner area of the mounting bucket, the vacuum cleaner including:
a collector module configured to collect debris and having a canister assembly disposed in the vacuum cleaner area; and
a vacuum module configured to draw a vacuum and operatively coupled to the collector module, the vacuum module including a hose having an end, the hose extending from the vacuum module into the hose storage area of the mounting bucket and the end extending out of the opening in the front portion of the mounting bucket and into the holster,
where the end of the hose is removably secured to the holster and accessible from an area outside of the mounting bucket.

11. The vacuum cleaner assembly of claim 10, wherein the vacuum cleaner area of the mounting bucket further includes an angled surface and a latch, and the canister assembly of the collector module is disposed on the angled surface and secured to the vacuum cleaner area by the latch.

12. The vacuum cleaner assembly of claim 10, wherein the vacuum module includes a motor/impeller unit disposed within a motor housing.

13. The vacuum cleaner assembly of claim 10, wherein the mounting bucket includes one or more of a rear wall having a plurality of wall mount holes and a bottom wall having a plurality of floor mount holes, the mounting bucket providing a single-piece mounting body for the vacuum cleaner assembly.

14. The vacuum cleaner assembly of claim 13, wherein the vehicle is a sleeper cab truck, and the mounting bucket is adapted to be secured to a rear wall of the sleeper cab truck, such that the holster is accessible below a sleeping bed of the sleeper cab truck.

15. The vacuum cleaner assembly of claim 10, further comprising a lid secured to the mounting bucket and enclosing the hose storage area, the lid including the front portion with the opening.

16. The vacuum cleaner assembly of claim 10, wherein the holster includes a body having a power switch and a nesting section disposed in one end of the body, the nesting section for receiving and maintaining a position of the end of the hose when the hose is not in use.

17. The vacuum cleaner assembly of claim 16, wherein, when the end of the hose is disposed in the nesting section of the holster, power is maintained in an off mode.

18. A vacuum cleaner assembly configured to be mounted in a vehicle, the vacuum cleaner assembly comprising:
a mounting bucket having a rear portion with an opening, a vacuum cleaner area, a hose storage area, and a wall adapted to be mounted to a first side of an internal wall of the vehicle;
a holster aligned with the opening in the rear portion of the mounting bucket and adapted to be coupled to a second side of the internal wall of the vehicle;
a vacuum cleaner disposed in the vacuum cleaner area of the mounting bucket, the vacuum cleaner including:
a collector module configured to collect debris and having a canister assembly disposed on an angled surface of the vacuum cleaner area; and
a vacuum module configured to draw a vacuum and operatively coupled to the collector module, the vacuum module including a hose having an end, the hose extending from the vacuum module into the hose storage area of the mounting bucket and the end extending out of the opening in the rear portion of the mounting bucket and into the holster,
wherein the end of the hose is removably secured to the holster and accessible from a front area of the vehicle.

19. The vacuum cleaner assembly of claim 18, wherein the vacuum cleaner area of the mounting bucket further includes an angled surface and a latch, and the canister assembly of the collector module is disposed on the angled surface and secured to the vacuum cleaner area by the latch.

20. The vacuum cleaner assembly of claim 18, wherein the vacuum module includes a motor/impeller unit disposed within a motor housing.

21. The vacuum cleaner assembly of claim 18, wherein the rear wall includes a plurality of wall mount holes and the mounting bucket further includes a bottom wall having a plurality of floor mount holes, the mounting bucket providing a single-piece mounting body for the vacuum cleaner assembly.

22. The vacuum cleaner assembly of claim 18, wherein the vehicle is a sleeper cab truck, and the mounting bucket is adapted to be secured to an inside surface of a bed support wall of the sleeper cab truck, and the holster is adapted to be secured to an outside surface of the bed support wall of the sleeper cab truck adjacent to the opening in the rear portion of the mounting bucket, such that the holster is accessible outside of the bed support wall in a front area of the sleeper cab truck.

23. The vacuum cleaner assembly of claim 18, further comprising a lid secured to the mounting bucket and enclosing the hose storage area, the lid including the rear portion with the opening.

24. The vacuum cleaner assembly of claim 18, wherein the holster includes a body having a power switch and a nesting section disposed in one end of the body, the nesting section for receiving and maintaining a position of the end of the hose when the hose is not in use.

25. The vacuum cleaner assembly of claim 24, wherein, when the end of the hose is disposed in the nesting section of the holster, power is maintained in an off mode.

26. A sleeper cab truck comprising:
a bed support wall;
a rear wall disposed opposite the bed support wall;
a floor surface disposed between the bed support wall and the rear wall; and
a vacuum cleaner assembly disposed on the floor surface, the vacuum cleaner assembly comprising:
a mounting bucket having a vacuum cleaner area and a hose storage area, the vacuum cleaner area having an angled surface;
a vacuum cleaner disposed in the vacuum cleaner area of the mounting bucket, the vacuum cleaner including:
a collector module having a canister assembly disposed on the angled surface of the vacuum cleaner area; and
a vacuum module operatively coupled to the collector module, the vacuum module including a hose having an end, the hose extending from the vacuum module into the hose storage area of the mounting bucket,
where the mounting bucket is configured to expose the end of the hose through the hose storage area in any one of a plurality of arrangements to accommodate various mounting positions on the floor surface.

27. The sleeper cab truck of claim 26, wherein the plurality of arrangements of the end of the hose through the hose storage area includes one of a hose-through-a-top-portion configuration, a hose-through-a-front-portion configuration, and a hose-through-a-rear-portion configuration.

28. The sleeper cab truck of claim 26, wherein, when the plurality of arrangements is the hose-through-a-front-portion configuration, the mounting bucket further comprises a rear wall with a plurality of wall mounts, and the rear wall of the mounting bucket is mounted to the rear wall disposed opposite the bed support wall.

29. The sleeper cab truck of claim 27, wherein, when the plurality of arrangements is the hose-through-a rear-portion configuration, the mounting bucket further includes a rear wall with a plurality of wall mounts, the rear wall of the mounting bucket is mounted to a first side of the bed support wall, and a holster is mounted to a second side of the bed support wall, such that the end of the hose extends out of the hose storage area of the mounting bucket, through the bed support wall and into the holster.

30. The sleeper cab truck of claim 26, further including a holster one of coupled to one of a side of the bed support wall and aligned with an opening in a rear portion of the mounting bucket or coupled to a front portion of the mounting bucket and aligned with an opening in the front portion of the mounting bucket.

31. The sleeper cab truck of claim 26, wherein the holster includes a body having a power switch and a nesting section disposed in one end of the body, the nesting section for receiving and maintaining a position of the end of the hose when the hose is not in use.

32. The sleeper cab truck of claim 31, wherein, when the end of the hose is disposed in the nesting section of the holster, power is maintained in an off mode.

33. The sleeper cab truck of claim 26, wherein the mounting bucket includes at least one of a rear wall having a plurality of wall mount holes and a bottom wall having a plurality of wall mount holes, the mounting bucket providing a single-piece mounting body for the vacuum cleaner assembly.
